(19) United States
(12) Patent Application Publication
(10) Pub. No.: US 2023/0074945 A1
(43) Pub. Date: Mar. 9, 2023

(54) METHOD AND APPARATUS FOR DISPLAYING AND ANALYZING OPTION INFORMATION, DEVICE, AND STORAGE MEDIUM

(71) Applicant: FUTU NETWORK TECHNOLOGY (SHENZHEN) CO., LTD., Shenzhen (CN)

(72) Inventors: Zhenyuan JIANG, Shenzhen (CN); Xiao HUANG, Shenzhen (CN)

(21) Appl. No.: 17/984,251

(22) Filed: Nov. 10, 2022

Related U.S. Application Data
(63) Continuation of application No. PCT/CN2022/106087, filed on Jul. 15, 2022.

(30) Foreign Application Priority Data
Aug. 12, 2021 (CN) 202110928110.4

(51) Int. Cl. G06Q 40/04

(52) U.S. Cl. CPC G06Q 40/04

(57) ABSTRACT

The present disclosure provides a method and apparatus for displaying and analyzing option information, an electronic device, and a storage medium. The method includes: collecting operation data of a user on the terminal device; obtaining, based on the operation data, volatility data of an option selected by the user, in which the volatility data includes implied volatility and/or historical volatility of the option; determining chart data and analysis information of volatility of the option based on the volatility data; and displaying the chart data and the analysis information. According to embodiments of the present disclosure, assistance can be provided to a user, especially an option trader who uses short-swing trading or volatility trading, in analyzing data relevant to volatility of the option, data references can be provided to the user to allow the user to make a selection from different trading strategies, thereby improving user experience.

### CROSS-REFERENCES TO RELATED APPLICATIONS

This application is a continuation of PCT International Application No. PCT/CN2022/106087, filed on Jul. 15, 2022, which claims priority to Chinese Patent Application No. 202110928110.4 filed with China National Intellectual Property Administration on Aug. 12, 2021 and entitled “METHOD AND APPARATUS FOR DISPLAYING AND ANALYZING OPTION INFORMATION, DEVICE, AND STORAGE MEDIUM”, the entire disclosure of which is incorporated herein by reference for all purposes. No new matter has been introduced.

### FIELD

The present disclosure relates to the field of software technologies, and more particularly, to a method and apparatus for displaying and analyzing option information, an electronic device, and a storage medium.

### BACKGROUND

A volatility term structure describes a corresponding change in implied volatility as a remaining term of an option varies and can be used to observe a volatility change in options having a same strike price but different expiration dates.

A volatility smile describes a relation between implied volatilities and strike prices of options having a same expiration date.

An option volatility analysis is used to check a relation between implied volatility of a current option and historical volatility at each cycle of the current option. The option volatility analysis can help a user to analyze relevant data of implied volatility and historical volatility of a stock option for the user to make a selection from different trading strategies.

However, an application (APP) currently executed by a terminal device usually uses a Black-Sholes (BS) model or a similar single model for calculation of implied volatility indiscriminately, leading to poor accuracy of volatility of options and bringing a very large data error to the user. Consequently, the user may make incorrect judgment, which could result in a significant investment loss of the user. In addition, existing volatility-relevant chart data cannot present analysis relevant to volatility of options and lacks intuitive suggestions and conclusions, which imposes high requirements on the user's own expertise and impairs user experience.

### SUMMARY

The present disclosure provides a method and apparatus for displaying and analyzing option information, an electronic device, and a storage medium, which are capable of displaying chart data and analysis information of volatility of an option to a user, providing data references to the user to allow the user to make a selection from different trading strategies, and improving user experience.

In a first aspect, a method for displaying and analyzing option information is provided. The method is applied in a terminal device. The method includes: collecting operation data of a user on the terminal device; obtaining, based on the operation data, volatility data of an option selected by the user, in which the volatility data includes implied volatility and/or historical volatility of the option; determining, based on the volatility data, chart data and analysis information of volatility of the option; and displaying the chart data and the analysis information.

In a second aspect, a method for displaying and analyzing option information is provided. The method is applied in a server. The method includes: obtaining operation data of a user on a terminal device; obtaining, based on the operation data, volatility data of an option selected by the user, in which the volatility data includes implied volatility and/or historical volatility of the option; and transmitting the volatility data to the terminal device.

In a third aspect, an apparatus for displaying and analyzing option information is provided. The apparatus includes: a collection unit configured to collect operation data of a user on a terminal device; an obtaining unit configured to obtain, based on the operation data, volatility data of an option selected by the user, in which the volatility data includes implied volatility and/or historical volatility of the option; a processing unit configured to determine, based on the volatility data, chart data and analysis information of volatility of the option; and a display unit configured to display the chart data and the analysis information.

In a fourth aspect, an apparatus for displaying and analyzing option information is provided. The apparatus includes: an obtaining unit configured to obtain operation data of a user on a terminal device; a processing unit configured to determine, based on the operation data, volatility data of an option selected by the user, in which the volatility data includes implied volatility and/or historical volatility of the option; and a transmitting unit configured to transmit the volatility data to the terminal device.

In a fifth aspect, the present disclosure provides an electronic device. The electronic device includes a processor and a memory. The memory is configured to store a computer program. The processor is configured to invoke and execute the computer program stored in the memory to perform the method or any possible implementation thereof in the first aspect.

In a sixth aspect, the present disclosure provides an electronic device. The electronic device includes a processor and a memory. The memory is configured to store a computer program. The processor is configured to invoke and execute the computer program stored in the memory to perform the method or any possible implementation thereof in the second aspect.

In a seventh aspect, the present disclosure provides a computer-readable storage medium. The computer-readable storage medium is configured to store a computer program. The computer program causes a computer to perform the method in the first aspect or the second aspect or any implementation of the first aspect or the second aspect.

In an eighth aspect, a computer program product is provided. The computer program product includes computer program instructions. The computer program instructions cause a computer to perform the method in the first aspect or the second aspect or any implementation of the first aspect or the second aspect.

In a ninth aspect, a computer program is provided. The computer program causes a computer to perform the method in the first aspect or the second aspect or any implementation of the first aspect or the second aspect.

According to embodiments of the present disclosure, the chart data and the analysis information can be displayed to the user by collecting the operation data of the user on the terminal device, obtaining, based on the operation data, the volatility data of the option selected by the user, and further determining, based on the volatility data, the chart data and the analysis information of the volatility of the option. Therefore, according to the embodiments of the present disclosure, through displaying the chart data and the analysis information of the volatility of the option to the user, data references can be provided to the user to allow the user to make a selection from different trading strategies, thereby helping the user to decide on an option purchase and improving the user experience.

Further, according to the embodiments of the present disclosure, a chart of a volatility term structure can be presented to the user to analyze a volatility change of options having a same strike price but different expiration dates, so as to analyze relevant data of implied volatility of a stock option, thereby helping the user to decide on the option purchase and improving the user experience.

According to the embodiments of the present disclosure, a chart of the volatility smile can further be presented to the user to analyze a relation between the implied volatility and the strike prices of the options having the same expiration date, so as to analyze relevant data of the implied volatility of the stock option, thereby helping the user to decide on the option purchase and improving the user experience.

Therefore, according to the embodiments of the present disclosure, a chart and analysis information of a volatility analysis can be presented to the user to display, to the user, a relation between implied volatility and historical volatility of a current option, as well as the implied volatility, the historical volatility, a trend of an implied volatility mean value curve, and a position of a maximum value of a volatility premium of the option, thereby providing data references to the user to allow the user to make a selection from different trading strategies.

In addition, a system can also automatically analyze the volatility data, output interpretation information of the chart, analyze whether current implied volatility is overestimated or underestimated, and make recommendations relevant to the volatility of the option to help the user analyze the volatility, thereby improving the user experience.

### BRIEF DESCRIPTION OF THE DRAWINGS

In order to clearly explain technical solutions of embodiments of the present disclosure, accompanying drawings used in description of the embodiments will be briefly described below. Obviously, the accompanying drawings as described below are merely some embodiments of the present disclosure. Based on these drawings, other accompanying drawings can be obtained by those of ordinary skill in the art without creative effort.

FIG. 1 is a schematic diagram showing an application scenario according to an embodiment of the present disclosure.

FIG. 2 is a schematic flowchart illustrating a method for displaying and analyzing option information according to an embodiment of the present disclosure.

FIG. 3 is a specific example of a volatility term structure.

FIG. 4 is a specific example of a volatility smile.

FIG. 5 is a specific example of a volatility analysis.

FIG. 6 is an example of a data loading process according to an embodiment of the present disclosure.

FIG. 7 is an example of a chart data class diagram of a volatility term structure.

FIG. 8 is a specific example of calculating an expiration date.

FIG. 9 is an example of a chart data class diagram of a volatility smile.

FIG. 10 is a schematic flowchart illustrating drawing a volatility premium line.

FIG. 11 is an example of a data loading process of a volatility analysis.

FIG. 12 is an example of a chart data structure class diagram of a volatility analysis.

FIG. 13 is a schematic flowchart illustrating another method for displaying and analyzing option information according to an embodiment of the present disclosure.

FIG. 14 is a schematic structural diagram showing an apparatus for displaying and analyzing option information according to an embodiment of the present disclosure.

FIG. 15 is a schematic structural diagram showing another apparatus for displaying and analyzing option information according to an embodiment of the present disclosure.

FIG. 16 is a schematic structural diagram showing an electronic device according to an embodiment of the present disclosure.

### DESCRIPTION OF EMBODIMENTS

Technical solutions according to embodiments of the present disclosure will be described clearly and completely below in combination with accompanying drawings of the embodiments of the present disclosure. Obviously, the embodiments described below are only a part, rather than all, of the embodiments of the present disclosure. On a basis of the embodiments in the present disclosure, all other embodiments obtained by a those of ordinary skill in the art without creative labor shall fall within the scope of the present disclosure.

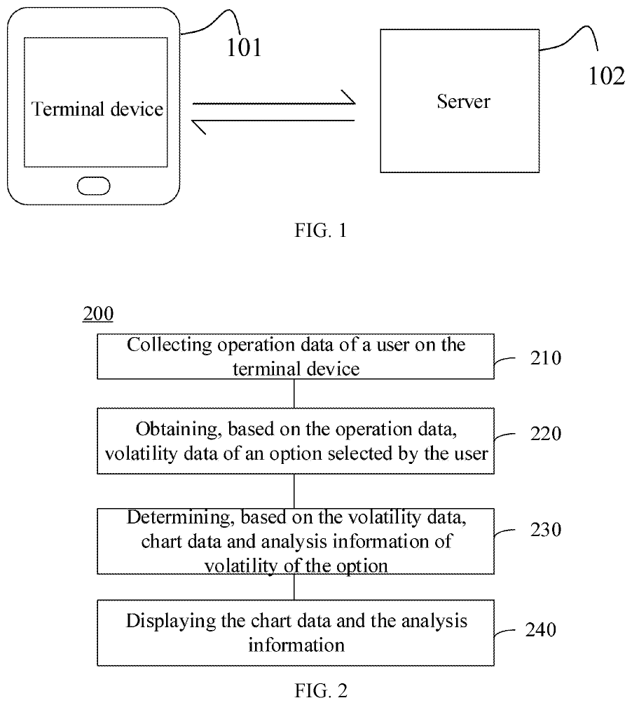

FIG. 1 is a schematic diagram showing an application scenario according to an embodiment of the present disclosure. The application scenario involves an electronic device 101 and an electronic device 102. The electronic device 101 may be any kind of terminal devices, such as a smart phone (e.g., an Android phone, an iOS phone, a Windows Phone, etc.), a tablet computer, a handheld computer, a laptop, a mobile Internet device, a wearable device, a vehicle-mounted device, etc. The electronic device 101 is not limited to any of these examples. The terminal device may also be called a User Equipment (UE), a terminal, a user device, etc., and is not limited to any of these examples. The electronic device 102 may be any type of servers, which is not limited in the embodiments of the present disclosure. The electronic device 101 and the electronic device 102 may transmit data through a wireless communication technology.

For example, a network architecture of the application scenario illustrated in FIG. 1 may be in a Client/Server (C/S) mode. A client side (e.g., a terminal device) can obtain chart-related data from a server side (e.g., a server) and processing and presenting the obtained chart-related data. As a specific example, the client side may adopt a Model-View-Presenter (MVP) architecture, which makes an interface, a data operation, and a data warehouse separate from each other.

For example, in an embodiment of the present disclosure, a user may input an instruction or data relevant to volatility of an option by operating the electronic device 101. The electronic device 101 receives, in response to an operation of the user, the instruction or data inputted by the user. After receiving the instruction or data inputted by the user, the electronic device 101 may transmit the instruction or data to the electronic device 102. The electronic device 102 may perform a data processing relevant to the volatility of the option after obtaining the instruction or data. The electronic device 102 may transmit the processed data to the electronic device 101. The electronic device 101 may perform a further processing on the data and present the data to the user.

It should be noted that the application scenario illustrated in FIG. 1 is only for illustrating, rather than limiting, the embodiments of the present disclosure. In a specific implementation, the technical solutions provided by the embodiments of the present disclosure may be flexibly applied as desired.

FIG. 2 is a schematic flowchart illustrating a method 200 for displaying and analyzing option information according to an embodiment of the present disclosure. The method 200 may be performed by the electronic device in FIG. 1. As illustrated in FIG. 2, the method 200 includes actions at 210 to 240.

At 210, operation data of a user on the terminal device is collected.

Optionally, the operation data may include at least one strike price of an option selected by the user and an expiration date of the option.

For example, the operation data of the user on the terminal device may be collected by a touch display screen. Here, the touch display screen may be, for example, a Thin Film Transistor Liquid Crystal Display (TFT-LCD), a Light Emitting Diode (LED) display screen, an Organic Light-Emitting Diode (OLED) display screen, etc., and is not limited to any of these examples.

At 220, volatility data of the option selected by the user is obtained based on the operation data. The volatility data includes implied volatility and/or historical volatility of the option. The historical volatility is a statistic of past prices of a stock. The implied volatility is a forecast of a future price of the stock. The historical volatility and the implied volatility represent two market sentiments, respectively.

Optionally, the volatility data may further include an implied volatility mean value. The implied volatility mean value is determined based on implied volatilities of at least two options having a same expiration date.

According to an embodiment of the present disclosure, the terminal device may obtain the volatility data of the option from the server. As a possible implementation, the terminal device may transmit a data access request to the server based on the operation data described above. The server returns corresponding volatility data based on the data access request. The server may calculate the volatility data, e.g., the implied volatility, the historical volatility, or the implied volatility mean value.

I. Implied Volatility

As a possible implementation, an implied volatility interval [lo, hi] may be initialized. The implied volatility iv may be calculated as following. That is, iv should satisfy: F(iv)=0. , iv∈[lo, hi]. Here, F(x)=f(x)−c, where f(x) represents a pricing model of the option, and c represents a market price of the option. That is, f(x) is relevant to a strike price and an expiration date of an option selected by the user.

It is experimentally concluded that different pricing models should be selected for f(x) for different options in terms of accuracy of iv. Preferably, for a European option, a Black-Scholes-Merton (BSM) model may be selected for f(x); and for an American option, a Barone-Adesi-Whaley (BAW) model may be selected for f(x). f(x) is relevant to a basic parameter such as an underlying price, a strike price, an expiration date, and an interest rate.

It is conceivable that an option price will rise as the implied volatility rises. That is, the option price is a monotonically increasing function of the implied volatility. Based on this, the implied volatility may be obtained by using the following method provided in this solution.

First, the implied volatility interval [lo, hi] is initialized, where lo represents a lower limit of the implied volatility interval, and hi represents an upper limit of the implied volatility interval. Then, a theoretical price corresponding to each of the upper limit hi and the lower limit lo of the implied volatility is calculated by f(x) and compared with the market price of the option. When the market price of the option falls within the above interval, a range of the interval is gradually narrowed by using the following approach and repeated, until a difference between the theoretical price of the option calculated by using f(x) and the market price of the option is in a sufficiently small range, in which case the solved implied volatility iv may make the theoretical price of the option equal to the market price of the option.

Specifically, let F(x)=f(x)−c. The implied volatility iv is solved when F(iv)=0, allowing the theoretical price of the option to be equal to the market price of the option.

An example of a process of gradually narrowing the range of the interval in accordance with a strategy of the present disclosure to determine the implied volatility iv will be described below.

First, the implied volatility interval [lo, hi] is initialized to allow F(lo)<0 and F(hi)>0,

∃iv∈[lo, hi], let F(iv)=0,

calculate

$$F ( \frac{lo + hi}{2} ) ,$$

when

$$F ( \frac{lo + hi}{2} ) = 0 ,$$

an iteration is stopped,

$$i v = ( \frac{lo + hi}{2} ) ;$$

when

$$F ( \frac{lo + hi}{2} ) < 0 ,$$

a new interval is

$$[ \frac{lo + hi}{2} , hi ] ;$$

and

when

$$F ( \frac{lo + hi}{2} ) > 0 ,$$

the new interval is

$$[ lo , \frac{lo + hi}{2} ] ;$$

where lo and hi, after being initialized, change as the new interval is generated, allowing the iteration to be achieved.

According to experimental data, it was found that a result obtained after the above calculation cannot be 0 in an extreme case. Therefore, in the present disclosure, the following restrictions are added to the calculation: when a range of a final new implied volatility interval fails to satisfy desired accuracy, or an error between the theoretical price of the option and an actual price of the option fails to satisfy the desired accuracy, or an upper limit of times of iterations is reached, the iteration is stopped, in which case iv is a lower limit value of the new implied volatility interval.

According to the experimental data, the above accuracy ranges from 0% to 1%. For the European option, the accuracy is preferably 0.43% and the upper limit of the times of iterations is preferably 10,000. For the American option, the accuracy is preferably 0.52% and the upper limit of the times of iterations is preferably 15,000.

As an example, a default value of hi may be 10.0, and a default value of lo may be le-6. le-6 means 1 multiplied by 10 to the power of minus 6, i.e., 0.000001. However, in consideration of rules of a computer language, le-6 is used to avoid an error, thereby eliminating an error problem resulted from a direct use of 0.000001.

In some optional embodiments, for example, for a deep in-the-money option and a deep out-of-the-money option, in terms of the above values, it is possible that an initial condition F(hi)<0 since a value of c is relatively large, which may be manifested by a fact that when iv=hi, a deviation between the theoretical price of the option and the actual price of the option is still large. In this case, the upper limit hi of the implied volatility interval may be gradually increased. The above parameter may be adjusted for calculation of the implied volatility. A specific calculation process may be provided as below.

For a result iv outputted by the above approach, when |F(iv)/c|>α or hi−iv<β, the implied volatility interval [iv₁, hi₁] is initialized, iv₁=iv, hi₁=hi+Δ, where a represents a deviation threshold between the theoretical price and the actual price of the option, and represents accuracy of an error between the implied volatility and the upper limit of the implied volatility interval.

For the result iv outputted by the above approach, when |F(ivₙ₊₁)−F(ivₙ)|≤γ, the iteration is stopped, iv_{new}=ivₙ₊₁, where n∈{1,2, . . . , N}, N represents an upper limit of times of cycles for solving the implied volatility cyclically, and γ represents accuracy of an error between theoretical prices of the option that are calculated based on two adjacent results of solved implied volatilities.

For the result iv outputted by the above approach, when |F(ivₙ₊₁)−F(ivₙ)|>γ, the implied volatility interval is [ivₙ₊₁, hi+(n+1)*Δ], and implied volatility ivₙ₊₂ is determined, where Δ represents an upward revision of the upper limit of the implied volatility interval. As an example, the implied volatility ivₙ₊₂ may be determined by using a bisection method.

For the result iv outputted by the above approach, when the times of iterations reach N, the iteration is stopped, iv_{new}=iv_{N}.

According to the experimental data, the default value of hi is preferably 10.0, the default value of lo may be le-6, a is preferably 0.10, is preferably 0.10, Δ is preferably 10.0, γ is preferably 1.0, and N is preferably 10.0. Here, still, le-6 means 1 multiplied by 10 to the power of minus 6, i.e., 0.000001. A principle of adopting le-6 rather than 0.000001 is explained above. The present disclosure is not limited in this regard.

II. Historical Volatility

As a possible implementation, historical volatility a may be determined based on the following equation:

$$σ = \sqrt{D \times \frac{{\sum }_{t = 2}^{T} {[ ( ln {P}_{t} - ln {P}_{t - 1} ) - \frac{1}{T - 1} {\sum }_{t = 2}^{T} ( ln {P}_{t} - ln {P}_{t - 1} ) ]}^{2}}{T - 2}}$$

where D represents a number of days in a cycle for displaying the historical volatility, T represents a number of underlying trading days of the option, {Pₜ} represents an underlying split-adjusted price series of the option, and t=1, 2, . . . , T.

Split-adjusted share price: price after stock split(s)=(current price−cash bonus)÷(1+a percentage of change for tradable shares)

In the calculation of the historical volatility, input parameters are a number of underlying trading days T of the option and the underlying split-adjusted share price series {Pₜ} of the option, and an output parameter is the historical volatility a.

According to the experimental data, the default value of D may be 5, 20, 30, 60, 120, or 250, and preferably 250. That is, by default, the system considers it more accurate to display the historical volatility in a 250-day cycle.

III. Implied Volatility Mean Value

The implied volatility mean value σ′ is relevant to λᵢ. A corresponding calculation equation of the implied volatility mean value σ′ obtained from the experimental data is:

$${σ}^{′} = \frac{2 [ {λ}_{1} \cdot {σ}_{1} + {λ}_{2} \cdot {σ}_{2} + … + {λ}_{i} \cdot {σ}_{i} ]}{\sqrt{{λ}_{1}^{2} + {λ}_{2}^{2} + … + {λ}_{i}^{2}} + \sqrt{{σ}_{1}^{2} + {σ}_{2}^{2} + … + {σ}_{i}^{2}}}$$

In the equation, λᵢ represents a distance coefficient between the strike price and the current price of the option. A calculation equation of the distance coefficient λᵢ obtained from the experimental data is:

$${λ}_{i} = \{ \begin{matrix}{( \frac{\vert {s}_{i} - p \vert}{p} - α )}^{2} & \frac{\vert {s}_{i} - p \vert}{p} < α \\ 0 & \frac{\vert {s}_{i} - p \vert}{p} > α\end{matrix}$$

In the equation, N represents a number of options having a same expiration date, a represents a maximum percentage distance threshold, σᵢ, which is obtained from the above calculation equation, represents an implied volatility value series of the options having the same expiration date, where i=1, 2, . . . , N, p represents an underlying current price of the option, and sᵢ represents a strike price series of the options having the same expiration date, where i=1, 2, . . . , N.

At 230, chart data and analysis information of volatility of the option is determined based on the volatility data.

For example, the chart data and the analysis information of the volatility includes at least one of the volatility term structure, the volatility smile, or the volatility analysis.

Here, the volatility term structure is used to indicate a relation (or a curve) between implied volatility of a specified strike price of the option and an expiration date of the option, and may be used to observe a volatility change of options having a same strike price but different expiration dates.

The volatility smile is used to indicate a relation (or a curve) between the implied volatility of the option and a strike price of the option. Usually, implied volatilities of the deep out-of-the-money option and the deep in-the-money option is higher than implied volatility of an at-the-money option, allowing an overall trend of the implied volatility to present a smiling mouth shape. This is also the reason why the trend of the implied volatility is called the volatility smile.

The volatility analysis is used to indicate analysis information on the implied volatility of the option. The analysis information may be obtained based on at least one of the implied volatility, the historical volatility, a volatility premium, or the implied volatility mean value of the option. In some optional embodiments, the volatility analysis is also used to indicate a relation (or a curve) between the implied volatility and the historical volatility of the option, or to indicate at least one of an implied volatility curve, a historical volatility curve, a volatility premium curve, and an implied volatility mean value curve.

In the present disclosure, data references can be provided to the user to allow the user to make a selection from different trading strategies through displaying the analysis information on the implied volatility of the option, and/or a relation between the implied volatility and the historical volatility of the current option, and/or at least one of the implied volatility, the historical volatility, the volatility premium, or the implied volatility mean value. For example, the user may buy the option when the implied volatility is lower than the historical volatility or sell the option when the implied volatility is higher than the historical volatility.

Empirical data shows that the implied volatility is always higher than the historical volatility in both the long term and the short term. That is, an option market overestimates actual volatility of the stock. However, a high difference between the implied volatility and the historical volatility may indicate a high premium of the current option. The volatility premium is equal to a difference obtained by subtracting the historical volatility from the implied volatility.

In some optional embodiments, a maximum value of the volatility premium of the option may also be obtained. Also, a volatility premium line may be generated at a data point corresponding to the maximum value of the volatility premium. The volatility premium is a positive difference value between the implied volatility of the option and the historical volatility of the option.

In some optional embodiments, the implied volatility mean value is determined based on implied volatilities of at least two options having a same expiration date. Specifically, reference to the implied volatility mean value may be made to the description above, and details thereof will be omitted here.

At 240, the chart data and the analysis information are displayed.

Specifically, at least one of the volatility term structure, the volatility smile, or the volatility analysis may be displayed by the terminal device.

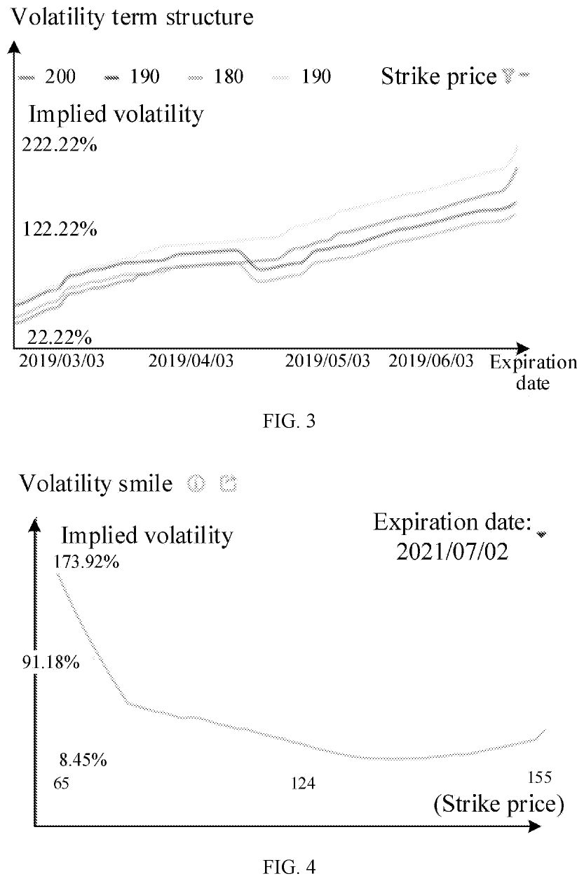

FIG. 3 illustrates a specific example of the volatility term structure. An X-axis in the drawing represents the expiration date of the option, a range of which is an expiration date range of the option at the specified strike price of the stock and displayed in a chronological order. A Y-axis in the drawing represents the implied volatility of the option, ranging from a minimum value of data to a maximum value of the data. An upper part and a lower part of the Y-axis may be partially left blank. The minimum value of the Y-axis is greater than zero.

The legend in FIG. 3 is strike prices of the option. For example, four legends may be displayed. For example, four strike prices closest to the current price of the stock are displayed, two of which are greater than the current price, and two of which are smaller than the current price. According to an embodiment of the present disclosure, the curve may be displayed or hidden by clicking on the legend, and may be re-drawn when the curve in the drawing changes. When a curve only has one data point, a single point may still be drawn. When one point needs to be displayed in the entire drawing, the point and the date on the X-axis may be centrally displayed. When no data needs to be displayed by a curve, the legend may be grayed out.

In some optional embodiments, the user can make a strike price selection by opening a strike price screening page to allow different strike price information to be displayed on the page. For example, the user may select, via a screening control, the strike price to be displayed in the drawing. For example, up to 4 prices and at least one price may be selected. If none price is selected, a finish button is grayed out and becomes un-clickable. In addition, the screening control displays the interval at which the current price of the stock is located by default, with a dotted line of the current price displayed as a division line.

As illustrated in FIG. 3, when the implied volatility curve tilts upwards, it usually means that the market expects the volatility of the stock to increase in the future. When the implied volatility curve tilts downwards, it usually means that the market expects the volatility of the stock to decrease in the future. For example, the volatility term structure may be applied in construction of a calendar spread strategy of the option. However, the volatility term structure is not limited to such an example.

Therefore, according to the embodiments of the present disclosure, the chart of the volatility term structure can be presented to the user to analyze changes of the volatilities of the options having the same strike price but different expiration dates, thereby analyzing relevant data of the implied volatility of the stock option to help the user to decide on the option purchase. Therefore, the user experience is improved.

FIG. 4 illustrates a specific example of the volatility smile. An X-axis in the drawing represents the strike price of the option, ranging from a minimum strike price to a maximum strike price on the expiration date. A Y-axis in the drawing represents the implied volatility of the option, ranging from a minimum value to a maximum value of data. An upper part and a lower part of the Y-axis may be partially left blank. The minimum value of the Y-axis is greater than zero. The chart may display by default the unexpired date closest to the current date. In FIG. 4, the expiration date is selectable on an upper right part of the chart. For example, all expiration dates of the option of the stock may be selected. The volatility smile may be applied in construction of a vertical spread strategy of the option. However, the present disclosure is not limited to such an example.

Therefore, according to the embodiments of the present disclosure, the chart of the volatility smile can be presented to the user to analyze the relation between the implied volatility and the strike price of the option on the same expiration date, thereby analyzing relevant data of the implied volatility of the stock option to help the user to decide on the option purchase. Thus, the user experience is improved.

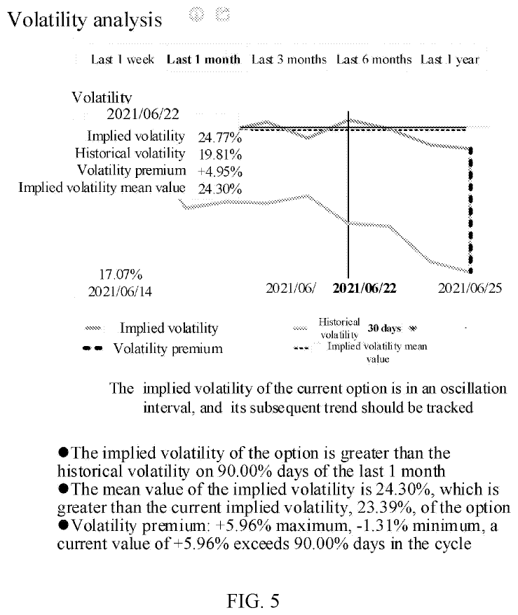

FIG. 5 illustrates a specific example of a volatility analysis. Different cycles may be selected for the historical volatility. For example, the historical volatility may be displayed in the 250-day cycle by default. The implied volatility may be implied volatility of the option at the close of each trading day. The historical volatility is underlying historical volatility corresponding to the option. According to an embodiment of the present disclosure, drawing may be made on a daily basis. For example, 5 cycles, i.e., last 1 week (5 points), last 1 month (20 points), last 3 months (60 points), last 6 months (120 points), and last 1 year (250 points), may be drawn. By default, volatility over last 1 month may be displayed, in which case when there are insufficient data points, all may be displayed.

An X-axis in FIG. 5 displays dates, ranging from an earliest date to a latest date, and with one date being displayed in the middle of the dates. A Y-axis in FIG. 5 displays values of the volatility, ranging from a minimum value to a maximum value in the interval. An upper part and a lower part of the Y-axis may be partially left blank. The minimum value of the Y-axis is greater than zero. In this drawing, a dotted gray curve of a latest implied volatility mean value may be displayed, and a dotted curve of the volatility premium may be drawn at a place where the difference between the implied volatility and the historical volatility is maximum. The legend in FIG. 5 may display the implied volatility, the implied volatility mean value, the volatility premium, and the historical volatility. When the volatility premium is positive, it may be shown with a “+” sign.

In some optional embodiments, the user may switch among different cycles of the historical volatility, e.g., HV5, HV20, HV30, HV60, HV90, HV120, HV250. By default, the cycle of HV30 may be displayed. A legend of the historical volatility is displayed in accordance with the selection of the user. The chart may support a cross hover window to display the implied volatility, the historical volatility, the volatility premium, and a volatility mean value on each date. All legends, except a legend of the implied volatility, may be displayed and hidden. When the historical volatility is hidden, the volatility premium is also hidden.

In some optional embodiments, the analysis information on the implied volatility of the option includes at least one of an overestimation of the implied volatility, an underestimation of the implied volatility, or an oscillation of the implied volatility. That is, the volatility analysis may include three types of chart interpretations, namely the overestimation, the underestimation, and a volatility oscillation.

A condition for reaching the overestimation (i.e., the analysis information of the implied volatility indicates the overestimation) may be at least one of:

1. the latest implied volatility has a cycle quantile exceeding 70%, and is greater than the historical volatility when the cycle quantile is not smaller than 70%; or

2. the latest volatility premium exceeds 70% volatility premiums within the cycle;

3. the latest implied volatility is greater than the implied volatility mean value.

Here, the cycle quantile of the latest implied volatility exceeding 70% indicates that a value of the latest implied volatility ranks in the top 30% of a cycle series of the implied volatility.

A condition for reaching the underestimation (i.e., the analysis information of the implied volatility indicates the underestimation) may be at least one of:

1. the latest implied volatility has a cycle quantile below 30%, and a point where the latest implied volatility is smaller than the historical volatility appears;

2. the latest volatility premium is negative or lower than 30% volatility premiums within the cycle; or

3. the latest implied volatility is smaller than or equal to the implied volatility mean value.

Here, the cycle quantile of the latest implied volatility being below 30% indicates that the value of the latest implied volatility ranks in the bottom 30% of the cycle series of the implied volatility.

Conditions other than the above conditions of the overestimation and the underestimation may be expressed as the oscillation of the implied volatility, and the present disclosure is not limited thereto.

Therefore, according to the embodiments of the present disclosure, the chart and the analysis information of the volatility analysis can be presented to the user to display, to the user, the relation between the implied volatility and the historical volatility of the current option, as well as the implied volatility, the historical volatility, the trend of the implied volatility mean value curve, and a position of the maximum value of the volatility premium of the option, thereby providing data references to the user to allow the user to make a selection from different trading strategies.

In addition, the system may also automatically analyze the volatility data, output interpretation information of the chart, analyze whether current implied volatility is overestimated or underestimated, and make recommendations relevant to the volatility of the option, thereby improving the user experience.

In some optional embodiments, a volatility term structure function and a volatility smile function may be located in a volatility tab on an option page. For example, an option volatility tab may be added to an option chain interface of an individual stock. A volatility analysis function may be located on an analysis page of the option. For example, on an analysis page of an individual option, a function navigation bar may be added, and a function volatility analysis tab may be added. Optionally, the added function navigation bar may also include a profit-loss analysis tab, the present disclosure is not limited in this regard.

A data loading process for a tab of each of the volatility term structure, the volatility smile, and the volatility analysis is explained below.

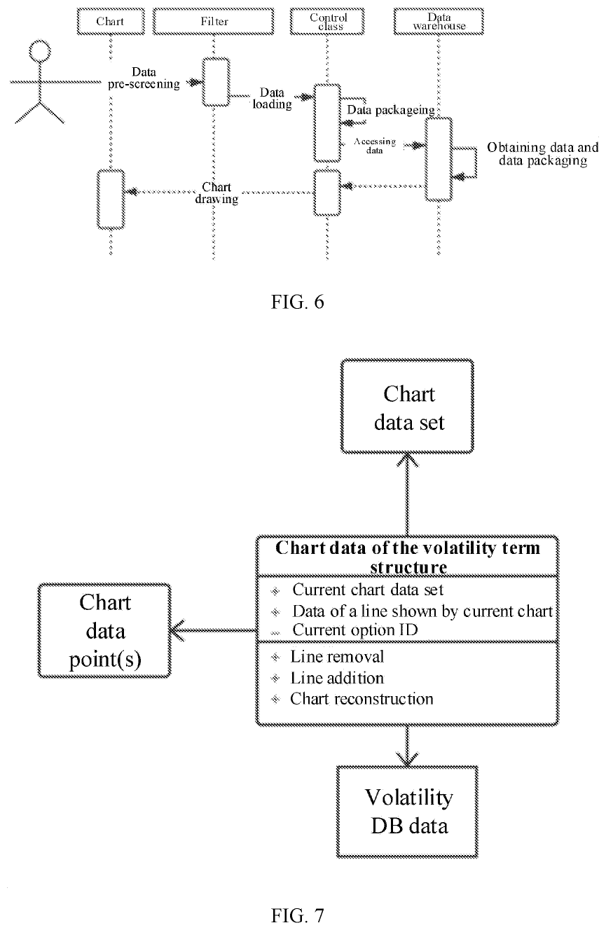

FIG. 6 illustrates an example of a data loading process according to an embodiment of the present disclosure. As illustrated in FIG. 6, after the user selects volatility information of an option that he/she wants to view through a filter, a controller accesses a data warehouse and obtains the volatility data remotely from the server. The data is repackaged, and handed over to the chart for drawing a curve and displaying the relevant data.

In the packaging of chart data, a conversion from database (db) data to page data may be performed, mainly for mismatching of the chart data. FIG. 7 illustrates an example of a chart data class diagram of a volatility term structure. The terminal device may extract a chart data set, chart data points, and volatility db data from the chart data of the volatility term structure, and draw and display the chart.

In some optional embodiments, a list of expiration date data of the option may be obtained from the server; and the expiration date of the option is obtained based on the list of expiration date data. The expiration date of the option is an unexpired date, closest to a current date, in the list of expiration date data.

Specifically, the data loading process for a tab of the volatility smile may also involve a full loading process of the list of expiration date data in addition to a normal chart data loading. The list of expiration date data is loaded only once during an entire lifetime of the tab and may be used by the user to allow the user to select the expiration date. The expiration date data is front-loading of loading the entire chart data of the tab of the volatility smile.

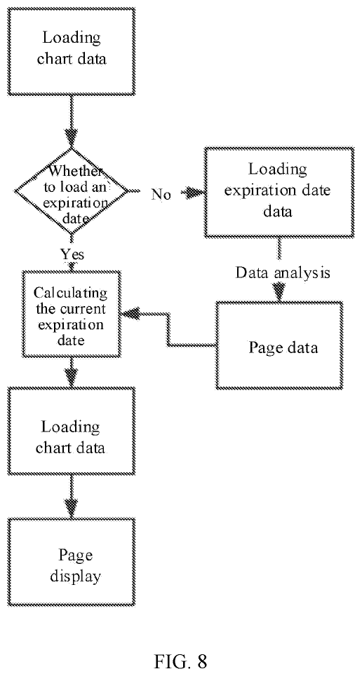

The expiration date manually selected by the user may be remembered in a lifetime of an App. However, a default value of the expiration date first loaded needs to be obtained through data calculation. FIG. 8 illustrates a specific example of calculating the expiration date. Specifically, the unexpired date closest to the current expiration date is found from a list of expiration dates obtained by the server. When such an unexpired date cannot be found, an ending expiration date is selected.

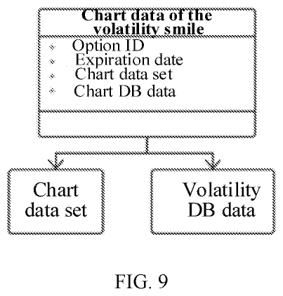

FIG. 9 illustrates an example of a chart data class diagram of a volatility smile. The terminal device may extract the chart data set and the volatility db data from the chart data of the volatility smile, and draw and display the chart.

In some optional embodiments, for a volatility analysis tab, the volatility chart data on the option page may be analyzed from two perspectives due to a large amount of content of the volatility chart data, one being an option cycle and the other being a historical volatility cycle. For example, the data in the two different perspectives may be screened to allow the chart to display data desired by the user.

For example, the option cycle may be defined by enumeration. The enumeration is updated upon switching of the cycle; and the historical volatility cycle may also be defined by the enumeration, including a type of cycle db data.

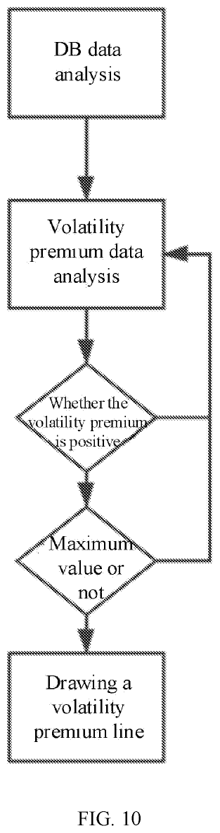

FIG. 10 illustrates a schematic flowchart for drawing a volatility premium line. As illustrated in FIG. 10, the client side resolves, based on a return packet obtained from the server, all the data that represents a relation between the expiration date and the volatility in the chart. Then, a point having the largest difference between the implied volatility and the historical volatility is found out from all the data points, and data indicated by this point has a positive volatility premium. For example, the point having the largest difference may be found out by using a cyclic traversal method, or a hashing algorithm, or a longest increasing subsequence lookup method. A straight line of the volatility premium is drawn between the implied volatility and the historical volatility by using data borne by the point.

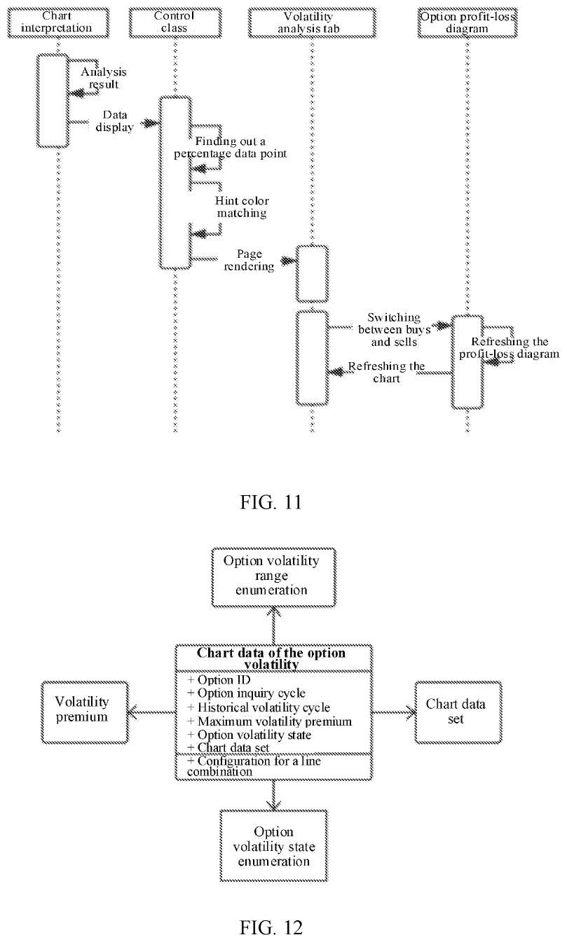

FIG. 11 illustrates an example of a data loading process of a volatility analysis. As illustrated in FIG. 11, after the system analyzes current data, a chart interpretation module may distinguish the analysis result with different colors. Optionally, the system may also jump to a corresponding option profit-loss diagram to perform a deeper data analysis.

FIG. 12 illustrates an example of a chart data structure class diagram of a volatility analysis. The terminal device may extract, from the chart data of the volatility analysis, enumeration of volatility ranges of the option, the volatility premium, enumeration of volatility states of the option, and the chart data set, and draw and display the chart.

According to embodiments of the present disclosure, the chart data and the analysis information can be displayed to the user through collecting the operation data of the user on the terminal device, obtaining the volatility data of the option selected by the user based on the operation data, and further determining the chart data and the analysis information of the volatility of the option based on the volatility data. Therefore, according to the embodiments of the present disclosure, through displaying the chart data and the analysis information of the volatility of the option to the user, data references can be provided to the user to allow the user to make the selection from different trading strategies, thereby helping the user to decide on the option purchase and improving the user experience.

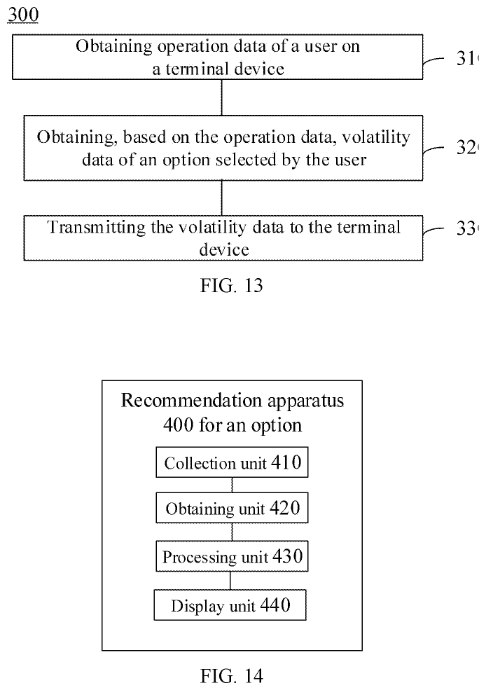

FIG. 13 illustrates a schematic flowchart of another method 300 for displaying and analyzing option information according to an embodiment of the present disclosure. The method 300 may be performed by the server, e.g., the electronic device 102 illustrated in FIG. 1. The server is not limited in this regard. As illustrated in FIG. 13, the method 300 includes actions at 310 to 330.

At 310, operation data of the user on the terminal device is obtained.

Specifically, the terminal device may transmit the operation data to the server after collecting the operation data of the user on the terminal device.

At 320, the volatility data of the option selected by the user is determined based on the operation data.

At 330, the volatility data is transmitted to the terminal device.

Specifically, description of the actions at 310 to 330 may be referred to the description of the action at 220 in the above method 200, and details thereof will be omitted here.

In some optional embodiments, obtaining the volatility data of the option selected by the user based on the operation data includes: initializing an implied volatility interval [lo, hi]; and determining the implied volatility iv, where iv satisfying: F(iv)=0, iv∈[lo, hi]. Here, F(x)=f(x)−c, where f(x) represents a pricing model of the option, and c represents a market price of the option. f(x) is relevant to the strike price and the expiration date of the option.

In some optional embodiments, obtaining the volatility data of the option selected by the user based on the operation data further includes: when |F(iv)/c|>α or hi−iv<β, initializing the implied volatility interval [iv₁, hi₁], iv₁=iv, hi₁=hi+Δ, where a represents a deviation threshold between the theoretical price and the actual price of the option, and βrepresents accuracy of an error between the implied volatility and the upper limit of the implied volatility interval; when |F(ivₙ₊₁)−F(ivₙ)|≤γ, stopping the iteration, iv_{new}=ivₙ₊₁, where n∈{1,2, . . . , N}, N represents an upper limit of times of cycles for solving the implied volatility cyclically, and γ represents accuracy of an error between theoretical prices of the option that are calculated based on two adjacent results of solved implied volatilities; when |F(ivₙ₊₁)−F(ivₙ)|>γ, obtaining that the implied volatility interval is [ivₙ₊₁, hi+(n+1)*Δ], and determining an implied volatility ivₙ₊₂, where Δ represents an upward revision of the upper limit of the implied volatility interval; and when the times of iterations reach N, stopping the iteration, iv_{new}=iv_{N}.

In some optional embodiments, the volatility data further includes the implied volatility mean value. The implied volatility mean value is determined based on implied volatilities of at least two options having the same expiration date.

In some optional embodiments, the implied volatility mean value is determined in accordance with the following equations:

$${σ}^{′} = \frac{2 [ {λ}_{1} \cdot {σ}_{1} + {λ}_{2} \cdot {σ}_{2} + … + {λ}_{i} \cdot {σ}_{i} ]}{\sqrt{{λ}_{1}^{2} + {λ}_{2}^{2} + … + {λ}_{i}^{2}} + \sqrt{{σ}_{1}^{2} + {σ}_{2}^{2} + … + {σ}_{i}^{2}}}$$

$${λ}_{i} = \{ \begin{matrix}{( \frac{\vert {s}_{i} - p \vert}{p} - α )}^{2} & \frac{\vert {s}_{i} - p \vert}{p} < α \\ 0 & \frac{\vert {s}_{i} - p \vert}{p} > α\end{matrix}$$

In the above equations, σ′ represents the implied volatility mean value, λᵢ represents a distance coefficient between the strike price of the option and the current price, N represents a number of options having a same expiration date, a represents a maximum percentage distance threshold, σᵢ represents an implied volatility value series of the options having the same expiration date, where i=1, 2, . . . , N, p represents an underlying current price of the option, and sᵢ represents a strike price series of the options having the same expiration date, where i=1, 2, . . . , N.

In some optional embodiments, the operation data includes at least one strike price of the option selected by the user and the expiration date of the option.

It should be understood that the method 300 and the method 200 may correspond to each other. Reference may be made to the embodiments of the method 200 for similar description of the method 300, and thus details thereof will be omitted here to avoid repetition.

Apparatus embodiments of the present disclosure will be described below and may be used to perform the above method embodiments of the present disclosure. For details not disclosed in the apparatus embodiments of the present disclosure, reference may be made to the above method embodiments of the present disclosure.

FIG. 14 is a schematic structural diagram showing an apparatus 400 for displaying and analyzing option information according to an embodiment of the present disclosure. As illustrated in FIG. 14, the apparatus according to the embodiment may include a collection unit 410, an obtaining unit 420, a processing unit 430, and a display unit 440.

The collection unit 410 is configured to collect operation data of a user on a terminal device.

The obtaining unit 420 is configured to obtain, based on the operation data, volatility data of an option selected by the user. The volatility data includes implied volatility and/or historical volatility of the option.

The processing unit 430 is configured to determine chart data and analysis information of volatility of the option based on the volatility data.

The display unit 440 is configured to display the chart data and the analysis information.

In some optional embodiments, the processing unit 430 is specifically configured to determine at least one of a volatility term structure, a volatility smile, or a volatility analysis of the option based on the volatility data of the option. The volatility term structure is used to indicate a relation between implied volatility of a specified strike price of the option and an expiration date of the option. The volatility smile is used to indicate a relation between the implied volatility of the option and a strike price of the option. The volatility analysis is used to indicate analysis information on the implied volatility of the option. The analysis information is obtained based on at least one of the implied volatility, the historical volatility, a volatility premium, or an implied volatility mean value of the option.

In some optional embodiments, the analysis information on the implied volatility of the option includes at least one of an overestimation, an underestimation, or an oscillation of the implied volatility.

In some optional embodiments, the obtaining unit 420 is further configured to: obtain a list of expiration date data of the option from a server; and obtain the expiration date of the option based on the list of expiration date data. The expiration date of the option is a default value or a date selected by the user from the list of expiration date data. The default value is an unexpired date, closest to a current date, in the list of expiration date data.

In some optional embodiments, the processing unit 430 is further configured to: obtain a maximum value of the volatility premium of the option, in which the volatility premium is a positive difference value between the implied volatility of the option and the historical volatility of the option; and generate a volatility premium line at a data point corresponding to the maximum value of the volatility premium.

In some optional embodiments, the implied volatility mean value is determined based on implied volatilities of at least two options having a same expiration date.

In some optional embodiments, the operation data includes at least one strike price of the option selected by the user and an expiration date of the option.

It should be understood that the apparatus embodiments may correspond to the method embodiments, and reference may be made to the method embodiments for similar description of the apparatus embodiments, and thus details thereof will be omitted here to avoid repetition. Specifically, the apparatus 400 for displaying and analyzing the option information illustrated in FIG. 14 may perform the method embodiments corresponding to FIG. 2, and the above and other operations and/or functions of each of the modules in the apparatus 400 are respectively configured to perform the method embodiments corresponding to FIG. 2, and thus details thereof will be omitted here for conciseness.

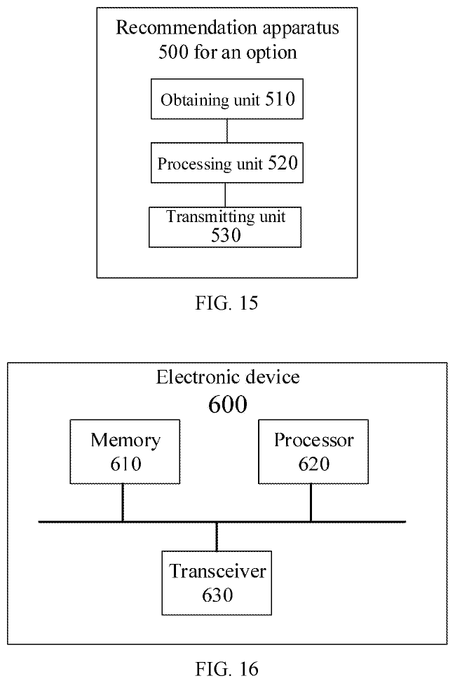

FIG. 15 is a schematic structural diagram showing another apparatus 500 for displaying and analyzing option information according to an embodiment of the present disclosure. As illustrated in FIG. 15, the apparatus according to the embodiment may include an obtaining unit 510, a processing unit 520, and a transmitting unit 530.

The obtaining unit 510 is configured to obtain operation data of a user on a terminal device.

The processing unit 520 is configured to determine, based on the operation data, volatility data of an option selected by the user. The volatility data includes implied volatility and/or historical volatility of the option.

The transmitting unit 530 is configured to transmit the volatility data to the terminal device.

Optionally, the processing unit 520 is specifically configured to: initialize an implied volatility interval [lo, hi]; and determine the implied volatility iv. iv satisfies: F(iv)=0, iv∈[lo, hi]. Here, F(x)=f(x)−c, where f(x) represents an option pricing model, and c represents a market price of the option. f(x) is relevant to a strike price and an expiration date of the option.

Optionally, the processing unit 520 is further configured to: when |F(iv)/c|>α or hi−iv<initialize the implied volatility interval [iv₁, hi₁], iv₁=iv, hi₁=hi+Δ, where a represents a deviation threshold between a theoretical price and a actual price of the option, and represents accuracy of an error between the implied volatility and an upper limit of the implied volatility interval; when |F(ivₙ₊₁)−F(ivₙ)|≤γ, stop the iteration, iv_{new}=ivₙ₊₁, where n∈{1,2, . . . , N}, N represents an upper limit of times of cycles for solving the implied volatility cyclically, and γ represents accuracy of an error between theoretical prices of the option that are calculated based on two adjacent results of solved implied volatilities; when |F(ivₙ₊₁)−F(ivₙ)|>γ, obtain that the implied volatility interval is [ivₙ₊₁, hi+(n+1)*Δ], and determine implied volatility ivₙ₊₂, where Δ represents an upward revision of the upper limit of the implied volatility interval; and when the times of iterations reach N, stop the iteration, iv_{new}=iv_{N}.

Optionally, the volatility data further includes an implied volatility mean value. The implied volatility mean value is determined based on implied volatilities of at least two options having a same expiration date.

Optionally, the operation data includes at least one strike price of the option selected by the user and an expiration date of the option.

It should be understood that the apparatus embodiments may correspond to the method embodiments, and reference may be made to the method embodiments for similar description of the apparatus embodiments, and thus details thereof will be omitted here to avoid repetition. Specifically, the apparatus 500 for displaying and analyzing the option information illustrated in FIG. 15 may perform the method embodiments corresponding to FIG. 13, and the above and other operations and/or functions of each of modules in the apparatus 500 are respectively configured to perform the method embodiments corresponding to FIG. 12, and thus details thereof will be omitted here for conciseness.

The apparatus 400 and the apparatus 500 for displaying and analyzing the option information according to the embodiments of the present disclosure are described above from the perspective of functional modules in conjunction with the accompanying drawings. It should be understood that the functional modules may be implemented in a form of hardware, by instructions in a form of software, or by a combination of hardware and software modules. Specifically, steps of the method embodiments in the embodiments of the present disclosure may be implemented by hardware integrated logic circuits in a processor and/or instructions in the form of software. The steps of the method that are disclosed in combination with the embodiments of the present disclosure may be directly embodied as being executed by a hardware decoding processor, or executed by a combination of hardware and software modules in the decoding processor. Optionally, the software module may be located in a mature storage medium in the art such as a random access memory, a flash memory, a Read-Only Memory (ROM), a Programmable ROM (PROM), an electrically erasable programmable memory, and a register. The storage medium is located in a memory. The processor reads information from the memory, and completes the steps in the above method embodiments in combination with hardware thereof.

FIG. 16 is a schematic structural diagram showing an electronic device 600 according to an embodiment of the present disclosure. As illustrated in FIG. 16, the electronic device 600 may include a memory 610 and a processor 620. The memory 610 is configured to store a computer program and transmit codes of the computer program to the processor 620. That is, the processor 620 can invoke and execute the computer program from the memory 610 to implement the method according to the embodiments of the present disclosure.

For example, the processor 620 is configured to perform the above method embodiments based on instructions in the computer program.

In some embodiments of the present disclosure, the processor 620 may include, but is not limited to, a general-purpose processor, a Digital Signal Processor (DSP), an Application Specific Integrated Circuit (ASIC), a Field Programmable Gate Array (FPGA), or another programmable logic device, a discrete gate or a transistor logic device, a discrete hardware component, etc.

In some the embodiments of the present disclosure, the processor 610 may include, but is not limited to, a volatile memory and/or a non-volatile memory. Here, the non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of illustration rather than limitation, RAMs in many forms are available, e.g., a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM)), and a Direct Rambus RAM (DR RAM).

In some embodiments of the present disclosure, the computer program may be divided into one or more modules. The one or more modules may be stored in the memory 610 and executed by the processor 620 to complete the method provided by the present disclosure. The one or more modules may be a series of computer program instruction segments capable of completing specific functions. The instruction segments are used to describe an execution process of the computer program in the electronic device.

As illustrated in FIG. 16, the electronic device may further include a transceiver 630 connectable to the processor 620 or the memory 610.

Here, the processor 620 may control the transceiver 630 to communicate with other devices, specifically, to transmit information or data to other devices, or receive information or data transmitted from other devices. The transceiver 630 may include a transmitter and a receiver. The transceiver 630 may further include one or more antennas.

It should be understood that various components in the electronic device are connected to each other via a bus system. Here, in addition to a data bus, the bus system also includes a power bus, a control bus, and a status signal bus.

The present disclosure further provides a computer storage medium. The computer storage medium has a computer program stored thereon. The computer program, when executed by a computer, causes the computer to perform the method according to the above method embodiments. Or, the embodiments of the present disclosure further provide a computer program product including instructions. The instructions, when executed by a computer, cause the computer to perform the method according to the above method embodiments.

When implemented by software, the above embodiments can be entirely or partially implemented in the form of a computer program product. The computer program product includes one or more computer instructions. When the computer program instructions are loaded and executed on a computer, the processes or functions described in the embodiments of the present disclosure are provided in whole or in part. The computer may be a general purpose computer, an application specific computer, a computer network, or any other programmable device. The computer instructions may be stored in a computer-readable storage medium or transmitted from one computer-readable storage medium to another computer-readable storage medium. For example, the computer instructions may be transmitted from one web site, computer, server, or data center to another web site, computer, server, or data center via a wired manner (such as a coaxial cable, an optical fiber, a Digital Subscriber Line (DSL)) or a wireless manner (such as infrared, wireless, microwave, etc.). The computer-readable storage medium may be any usable medium that can be accessed by a computer or a data storage device such as a server or a data center integrated with one or more usable medium. The usable medium may be a magnetic medium (for example, a floppy disk, a hard disk, a magnetic tape), an optical medium (for example, a Digital Video Disc (DVD)), or a semiconductor medium (for example, a Solid State Disk (SSD)), etc.

It should be understood that expressions such as first and second in the embodiments of the present disclosure are merely for illustrating and distinguishing the described objects, rather than describing a specific sequence or representing a specific limitation on a number of devices in the embodiments of the present disclosure, and thus can not constitute any limitation on the embodiments of the present disclosure.

It should also be understood that in the various embodiments of the present disclosure, numerical values of sequence numbers of the above processes are not intended to mean an execution order and should not constitute any limitation on an implementation process of the embodiments of the present disclosure as the execution order of individual processes should be determined by their functions and internal logics. It should be understood that data used in this way may be interchanged with each other under appropriate circumstances, such that the described embodiments of the present disclosure can be implemented in a sequence other than those illustrated or described in the present disclosure.

In addition, terms “include”, “have”, and any variations thereof are intended to cover non-exclusive inclusions. For example, a process, method, system, product, or server that includes a series of steps or units is not necessarily limited to those clearly listed steps or units, and may also include other steps or units that are not clearly listed or are inherent to the process, method, product, or device.

In the present disclosure, “at least one” refers to one or more, and “a plurality of” refers to two or more than two. “And/or” describes an association relationship between correlated objects, including three relationships. For example, “A and/or B” may mean A only, B only, or both A and B. Here, A and B may be singular or plural. The symbol “/” generally indicates an “or” relationship between the correlated objects preceding and succeeding the symbol. “At least one of the following items” or similar expressions refer to any combination of these items, including a single item or any combination of a plurality of items. For example, at least one of a, b, or c may represent a, b, c, a and b, a and c, b and c, or a, b, and c, where a, b, and c each may be singular or plural.

It should be understood that references to “one embodiment” or “an embodiment” throughout the specification imply that specific features, structures, or characteristics related to the embodiments are included in at least one embodiment of the present disclosure. Thus, expressions “in one embodiment” or “in an embodiment” throughout the specification do not necessarily refer to the same embodiment. In addition, these specific features, structures, or characteristics may be combined into one or more embodiments in any suitable manner.

It can be appreciated by those of ordinary skill in the art that the modules and the steps of the algorithm of various examples described in combination with the embodiments disclosed herein may be implemented in electronic hardware or a combination of computer software and electronic hardware, which depends on specific applications and design constraint conditions of technical solutions. For each specific application, professionals and technicians can use different methods to implement the described functions, and such an implementation should not be considered as going beyond the scope of the present disclosure.

In several embodiments provided by the present disclosure, it should be understood that the disclosed devices, apparatuses and methods can be implemented in other ways. For example, the apparatus embodiments described above are merely exemplary. For example, the modules are merely divided based on logic functions. In practical implementation, the modules may be divided in other manners. For example, multiple modules or components may be combined or integrated into another system, or some features may be omitted or not executed. In addition, mutual coupling or direct coupling or communication connection displayed or discussed may be implemented as indirect coupling or communication connection via some interfaces, apparatuses or modules, and may be electrical, mechanical or in other forms.

The modules illustrated as separate components may be or not be separated physically, and components shown as modules may be or not be physical modules, i.e., may be located at one position, or distributed onto multiple network units. It is possible to select some or all of the modules according to actual needs, for achieving the objective of the embodiments of the present disclosure. For example, respective functional modules in respective embodiments of the present disclosure may be integrated into one processing module, or may be present as separate physical entities. It is also possible to integrate two or more modules into one module.

The above description merely illustrates specific implementations of the present disclosure, and the scope of the present disclosure is not limited thereto. Change or replacement within the technical scope disclosed by the present disclosure that can be easily conceived by those skilled in the art shall fall within the scope of the present disclosure. Thus, the scope of the present disclosure should be defined by claims.

What is claimed is:

1. A method for displaying and analyzing option information, the method being applied in a terminal device, the method comprising:
collecting operation data of a user on the terminal device;
obtaining, based on the operation data, volatility data of an option selected by the user, wherein the volatility data comprises implied volatility and/or historical volatility of the option, wherein the implied volatility is obtained by updating an implied volatility interval based on a pricing model of the option and a market price of the option, and wherein the historical volatility is obtained based on a number of underlying trading days of the option and an underlying split-adjusted price series of the option;
determining, based on the volatility data, chart data and analysis information of volatility of the option; and
displaying the chart data and the analysis information.

2. The method according to claim 1, wherein said determining, based on the volatility data, the chart data and the analysis information of the volatility of the option comprises:
determining, based on the volatility data of the option, at least one of a volatility term structure, a volatility smile, or a volatility analysis of the option, wherein:
the volatility term structure is used to indicate a relation between implied volatility of a specified strike price of the option and an expiration date of the option;
the volatility smile is used to indicate a relation between the implied volatility of the option and a strike price of the option; and
the volatility analysis is used to indicate analysis information on the implied volatility of the option, the analysis information being obtained based on at least one of the implied volatility, the historical volatility, a volatility premium, or an implied volatility mean value of the option.

3. The method according to claim 2, wherein the analysis information on the implied volatility of the option comprises at least one of an overestimation, an underestimation, or an oscillation of the implied volatility.

4. The method according to claim 2, further comprising:
obtaining a list of expiration date data of the option from a server; and
obtaining the expiration date of the option based on the list of expiration date data, wherein the expiration date of the option is a default value or a date selected from the list of expiration date data by the user, the default value being an unexpired date, closest to a current date, in the list of expiration date data.

5. The method according to claim 2, further comprising:
obtaining a maximum value of the volatility premium of the option, wherein the volatility premium is a positive difference value between the implied volatility of the option and the historical volatility of the option; and
generating a volatility premium line at a data point corresponding to the maximum value of the volatility premium.

6. The method according to claim 2, wherein the implied volatility mean value is determined based on implied volatilities of at least two options having a same expiration date.

7. The method according to claim 1, wherein the operation data comprises at least one strike price of the option selected by the user and an expiration date of the option.

8. A method for displaying and analyzing option information, the method being applied in a server, the method comprising:
obtaining operation data of a user on a terminal device;
determining, based on the operation data, volatility data of an option selected by the user, wherein the volatility data comprises implied volatility and/or historical volatility of the option, wherein the implied volatility is obtained by updating an implied volatility interval based on a pricing model of the option and a market price of the option, and wherein the historical volatility is obtained based on a number of underlying trading days of the option and an underlying split-adjusted price series of the option; and
transmitting the volatility data to the terminal device.

9. The method according to claim 8, wherein said determining, based on the operation data, the volatility data of the option selected by the user, comprises:
initializing the implied volatility interval [lo, hi]; and
determining the implied volatility iv, wherein iv satisfies F(iv)=0, iv∈[lo, hi],
wherein F(x)=f(x)−c, where f(x) represents the pricing model of the option, and c represents the market price of the option, and f(x) is relevant to a strike price and an expiration date of the option.

10. The method according to claim 9, wherein said determining the implied volatility iv comprises:
when |F(iv)/c|>α or hi−iv<β, initializing the implied volatility interval [iv₁, hi₁], iv₁=iv, hi₁=hi+Δ, where a represents a deviation threshold between a theoretical price and an actual price of the option, and represents accuracy of an error between the implied volatility and an upper limit of the implied volatility interval;
when |F(ivₙ₊₁)−F(ivₙ)≤γ, stopping the iteration, iv_{new}=ivₙ₊₁, where n ∈{1,2, . . . , N}, N represents an upper limit of times of cycles for solving the implied volatility cyclically, and γ represents accuracy of an error between theoretical prices of the option that are calculated based on two adjacent results of solved implied volatilities;
when |F(ivₙ₊₁)−F(ivₙ)|>γ, determining that the implied volatility interval is [ivₙ₊₁, hi+(n+1)*Δ], and determining an implied volatility ivₙ₊₂, where Δ represents an upward revision of the upper limit of the implied volatility interval; and
when times of iterations reach N, stopping the iteration, iv_{new}=iv_{N}.

11. An electronic device, comprising:
a processor; and
a memory, having one or more programs stored thereon and executable by the processor,
wherein the one or more programs comprise instructions for performing steps of:
collecting operation data of a user on the electronic device;
obtaining, based on the operation data, volatility data of an option selected by the user, wherein the volatility data comprises implied volatility and/or historical volatility of the option, wherein the implied volatility is obtained by updating an implied volatility interval based on a pricing model of the option and a market price of the option, and wherein the historical volatility is obtained based on a number of underlying trading days of the option and an underlying split-adjusted price series of the option;
determining, based on the volatility data, chart data and analysis information of volatility of the option; and
displaying the chart data and the analysis information.

12. The electronic device according to claim 11, wherein said determining, based on the volatility data, the chart data and the analysis information of the volatility of the option comprises:
determining, based on the volatility data of the option, at least one of a volatility term structure, a volatility smile, or a volatility analysis of the option, wherein:
the volatility term structure is used to indicate a relation between implied volatility of a specified strike price of the option and an expiration date of the option;
the volatility smile is used to indicate a relation between the implied volatility of the option and a strike price of the option; and
the volatility analysis is used to indicate analysis information on the implied volatility of the option, the analysis information being obtained based on at least one of the implied volatility, the historical volatility, a volatility premium, or an implied volatility mean value of the option.

13. The electronic device according to claim 12, wherein the analysis information on the implied volatility of the option comprises at least one of an overestimation, an underestimation, or an oscillation of the implied volatility.

14. The electronic device according to claim 12, wherein the one or more programs further comprise instructions for performing steps of:
obtaining a list of expiration date data of the option from a server; and
obtaining the expiration date of the option based on the list of expiration date data, wherein the expiration date of the option is a default value or a date selected from the list of expiration date data by the user, the default value being an unexpired date, closest to a current date, in the list of expiration date data.

15. The electronic device according to claim 12, wherein the one or more programs further comprise instructions for performing steps of:
obtaining a maximum value of the volatility premium of the option, wherein the volatility premium is a positive difference value between the implied volatility of the option and the historical volatility of the option; and
generating a volatility premium line at a data point corresponding to the maximum value of the volatility premium.

16. The electronic device according to claim 12, wherein the implied volatility mean value is determined based on implied volatilities of at least two options having a same expiration date.

17. The electronic device according to claim 11, wherein the operation data comprises at least one strike price of the option selected by the user and an expiration date of the option.

18. An electronic device, comprising:
a processor; and
a memory, having one or more programs stored thereon and executable by the processor,
wherein the one or more programs comprise instructions for performing steps of the method according to claim 8.

19. A computer-readable storage medium, having a computer program stored thereon for electronic data exchange, wherein the computer program causes a computer to perform the method according to claim 1.

20. A computer-readable storage medium, having a computer program stored thereon for electronic data exchange, wherein the computer program causes a computer to perform the method according to claim 8.
